(19) United States
(12) Patent Application Publication
(10) Pub. No.: US 2003/0037111 A1
(43) Pub. Date: Feb. 20, 2003

(54) Image sharing system

(76) Inventor: Kiwamu Yoshioka, Saitama (JP)

Correspondence Address: RABIN & CHAMPAGNE, PC, 1101 14TH STREET, NW, SUITE 500, WASHINGTON, DC, 20005, US

(21) Appl. No.: 09/760,653

(22) Filed: Jan. 17, 2001

(30) Foreign Application Priority Data
Mar. 27, 2000 (JP) 086461/2000

(51) Int. Cl. G06F 15/16; G06F 17/60; G09G 5/00

(52) U.S. Cl. 709/205; 705/26; 705/35; 345/753

(57) ABSTRACT

In image sharing systems where work is carried out in collaboration by a plurality of computers connected via a network sharing an image, problems occur where results displayed for content of operations for each terminal do not coincide.

In the image sharing system of the present invention, a synchronization server is added to a related image sharing system, and the occurrence of mismatches in content displayed at the images of each image sharing terminal are resolved by sending content of operations of each image sharing terminal to a synchronization server once so as to bring about synchronization.

### BACKGROUND OF THE INVENTION

1. Field Of The Invention

The present invention relates to an image sharing system where a plurality of computers connected via a network collaborate by sharing an image.

2. Description Of The Related Art

The “image sharing system” described above is a system where an image (a document configured in any manner) is displayed simultaneously on a plurality of computers and can be changed or edited from any of the computers.

FIG. 1 shows an example configuration of a related image sharing system. FIG. 1 shows computers 101 and 102 (hereinafter referred to as image sharing terminals) sharing images displayed at display devices. A document server 103S provides documents configured on the shared image. Document acquisition communication paths 111 and 112 are also provided. The image sharing terminals 101 and 102 acquire documents via these communication paths 111 and 112 while documents are acquired by the document server 103S. A synchronization information communication path 113 is also provided, with the image sharing terminals 101 and 102 exchanging changes to the image via this synchronization information communication path 113. In this figure, the communication paths 111, 112 and 113 are directly connected between each terminal (101 and 102) and the server 103S. However, connections may also be made via a public line network, etc. or the communication path may be set using logic.

In order to adopt a related method for enabling image sharing, information for control use is exchanged mutually and directly between the image sharing terminals 101 and 102 via the synchronization information communication path 113. This is described in the following with reference to FIG. 1.

When a document displayed at an image of the image sharing terminal 101 of FIG. 1 is to be replaced, acquisition of the document is carried out by the document server 103S. However, prior to this (or upon completion), a message instructing a document acquisition is sent to the other image sharing terminal 102 via the synchronization information communication path 113 of FIG. 1. The image sharing terminal 102 receiving this message then acquires the same document as is displayed at the image sharing terminal 101 by the document server 103S shown in FIG. 1 in accordance with instructions within the message.

Further, when the same document is displayed at the image sharing terminals 101 and 102 of FIG. 1, when an operation such as a text input to an input region of the image of editing of displayed text etc. is carried out at the image sharing terminal 101, a notification message indicating the manner in which editing of specified configuration elements is to be performed is sent to the other image sharing terminal 102 via the synchronization information communication path 113 of FIG. 1. The image sharing terminal 102 receiving the message then makes changes with respect to elements of the displayed document configuration elements so that the displayed content matches with the content displayed at the image sharing terminal 101.

However, as described in the following, synchronization drift occurs with this related image sharing system and there is also a problem regarding compatibility with scattered sites.

### Synchronization Drift Problems

Consider the case, for example, where changing over of an image display is carried out from more than one location at the same time. This is described in the following with reference to FIG. 1.

Changes are made to a display image 1 at the image sharing terminal 101, while at substantially the same time, changes are made to a different display image 2 at the image sharing terminal 102. In this case, a message instructing the displaying of the display image 1 at the image sharing terminal 102 is sent from the image sharing terminal 101, which is passed by a message instructing the displaying of the display image 2 at the image sharing terminal 101 being sent from the image sharing terminal 102 in the other direction. When the messages received by the image sharing terminal 101 and the image sharing terminal 102 are executed, the document instructed by the display image 2 is displayed at the image sharing terminal 101 and the document instructed by the display image 1 is displayed at the image sharing terminal 102. This causes a discrepancy between the displayed content.

Consider the case where text input operations to an input region of the image are carried out from more than one location in a synchronous manner. This is described in the following with reference to FIG. 1.

Assume that the same document is displayed at the image sharing terminals 101 and 102 of FIG. 1. It is then taken that “M” is inputted to the text input region of the image at the image sharing terminal 101. At substantially the same time, a different character string “N” is inputted to the same text input region at the image sharing terminal 102. In this case, a message instructing for the content of the text input region to be replaced with “M” is sent from the image sharing terminal 101 to the image sharing terminal 102, and a message instructing for the content of the same text input region to be replaced with N is sent from the image sharing terminal 102 to the image sharing terminal 101. When the messages received by the image sharing terminal 101 and the image sharing terminal 102 are executed, “N” is displayed at the text input region of the image sharing terminal 101 and “M” is displayed at the same text input region of the image sharing terminal 102. This brings about a discrepancy between the displayed content.

### Compatibility Problems when Sharing Between Scattered Sites

Problems also occur with this method when image sharing is carried out between three or more image sharing terminals. FIG. 2 shows a configuration when three of the image sharing terminals of FIG. 1 are provided (the document server 103S of FIG. 1 is omitted in FIG. 2).

Assume that a phenomena requiring communication for some kind of image sharing occurs at the image sharing terminal 101 of FIG. 1, and that three terminals (101, 102, 103) are participating in image sharing. The image sharing terminal 101 has to send control documents to the image sharing terminal 102 and the image sharing terminal 103 and it is therefore necessary to set up communication paths with both the image sharing terminal 102 and the image sharing terminal 103. This is also the case for the image sharing terminals 102 and 103, which means that three communication paths (111, 112, 113) are required. Taking the number of terminals to be N, the number of communication paths is the N(N−1)/2.

In this image sharing system, the number of communication paths increases in the order of N² as the number of participating image sharing terminals increases. This not only makes implementation complex but also increases the load (network traffic) on the communication path, which makes image sharing between scattered sites difficult.

### SUMMARY OF THE INVENTION

The object of the present invention is to provide an image sharing system comprising a plurality of image sharing terminals, where differences between content displayed at images do not occur even when operations are carried out at respective image sharing terminals with respect to simultaneously displayed images.

A further object of the present invention is to provide an image sharing system where load on communications lines does not increase even when the number of image sharing terminals comprising the system increases and where image sharing between scattered sites is possible.

In order to achieve the aforementioned object, the image sharing system of the present invention is an image sharing system for displaying a shared image at a plurality of computer display devices connected via a network.

This system is provided with a synchronization server connected to the plurality of computers via a network. The synchronization server comprises receiving means for receiving content of operations carried out at the plurality of computers, accumulating means for accumulating and assigning order in order of receipt to received operation content, and distribution means for distributing operation content accumulated at the accumulating means to the plurality of computers in the order of accumulation.

### BRIEF DESCRIPTION OF THE DRAWINGS

FIG. 1 shows a typical configuration of a related image sharing system.

FIG. 2 is a view showing problems occurring with regards to compatibility with distributed site sharing in a related image sharing system.

FIG. 3 is a view showing a configuration of an image sharing system of a first embodiment.

FIG. 4 shows a configuration for an image sharing terminal.

FIG. 5 is a view showing a configuration for a document server

FIG. 6 is a view showing a configuration for a synchronization server.

FIG. 7 shows an example of a shared image.

FIG. 8 is a view showing distributed site sharing of a first embodiment.

FIG. 9 is a view showing an internal configuration of a request accumulator of a synchronization server of the second embodiment.

FIG. 10 is a view showing an internal configuration of a document sharing processor of an image sharing terminal of a fourth embodiment.

### DETAILED DESCRIPTION OF THE PREFERRED EMBODIMENTS

The following is a detailed description, with reference to the drawings, of preferred embodiments of the present invention.

### First Embodiment

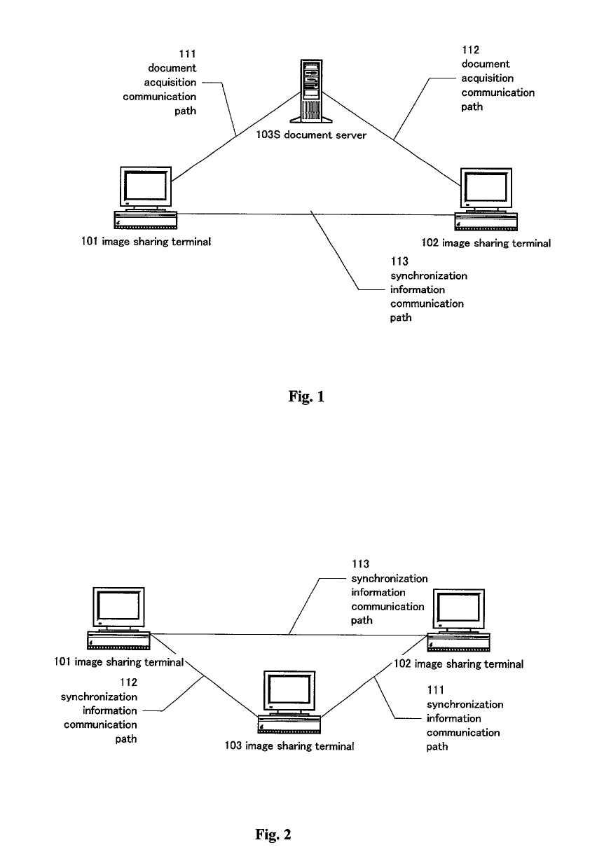

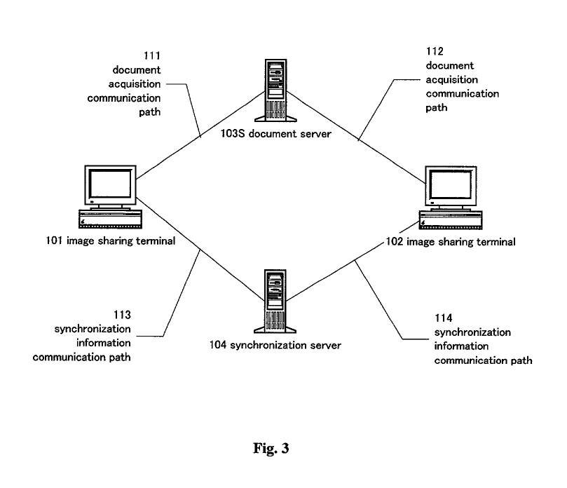

FIG. 3 shows a configuration for an image sharing system of this embodiment. Compared to the configuration of the related method shown in FIG. 1, a synchronization server 104 is added as a new element of the configuration. Other portions 101, 102, 103, 111 and 112 substantially correspond to the corresponding elements in FIG. 1. In other words, the image sharing terminals 101 and 102 do not communicate with each other directly, but rather are connected to a synchronization server 104 via the synchronization information communication paths 113 and 114. This connection state is not necessarily physical and simply setting a logical communication path is sufficient as in the case of the configuration of FIG. 1. Further, just one document server 103S is provided in the drawing but a plurality of document servers 103 may also be provided or a system configuration where a document server is first specified during execution can be adopted.

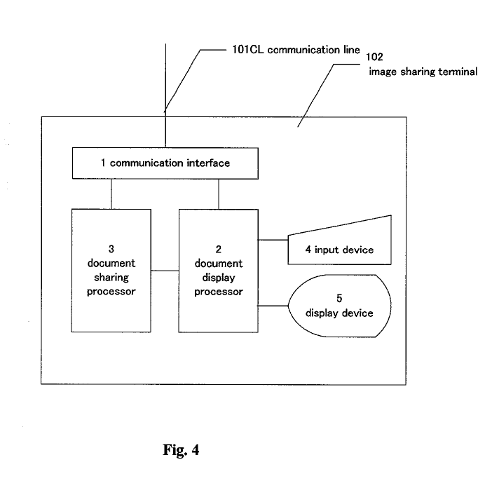

FIG. 4 shows a configuration for the image sharing terminals 101 and 102 of FIG. 3.

Here, numeral 101CL is a communication line and communication between this terminal and other terminals and the server is carried out via the communication line 101CL.

Here, the image sharing terminal 102 comprises a communication interface 1, a document display processor 2, a document sharing processor 3, a display device 4 and an input device 5. The input device 5 includes a keyboard for inputting characters and a pointing device. A specific region of the display device is designated using the pointing device, and the pressing of this region can be communicated.

The document display processor 2 acquires documents from the document server via the communication interface 1 and displays acquired documents at the display device 4.

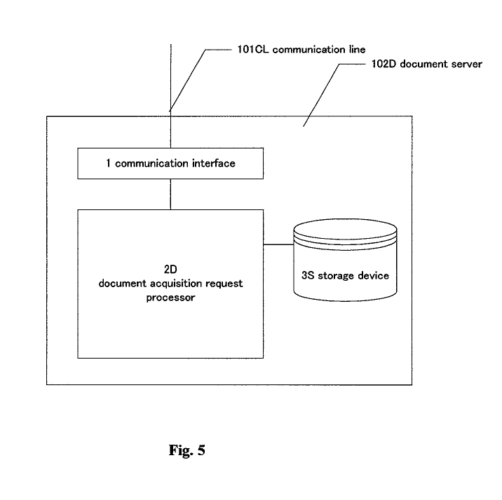

FIG. 5 shows a configuration for the document server 103S in FIG. 3.

Here, numeral 101 is a communication line and communication between this server and other terminals is carried out via the communication line 101CL.

Further, numeral 102D is a document server and comprises the communication interface 1, the document acquisition request processor 2D and the storage device 3S.

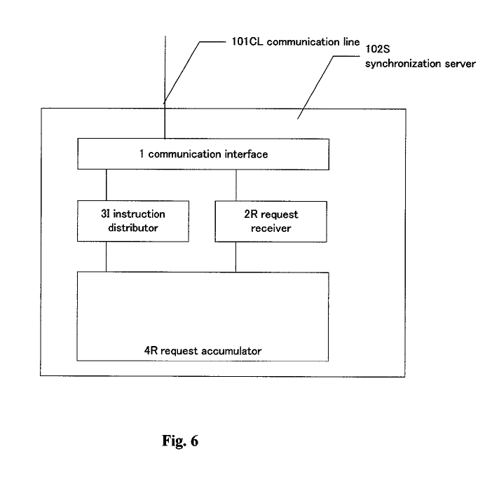

The document acquisition request processor 2D receives document acquisition requests via the communication interface 1, retrieves documents from the storage device 3S and sends these documents via the same interface 1. FIG. 6 shows a configuration for the synchronization server 104 in FIG. 3.

Here, numeral 101CL is a communication line for carrying out communication between this server and other terminals.

Further, numeral 102S is a synchronization server and comprises the communication interface 1, a request receiver 2R, an instruction distributor 3I and a request accumulator 4R.

In this embodiment, control information is not directly exchanged between the two terminals as in the related image sharing system but rather is exchanged via the synchronization server 104 in FIG. 3. All requests are put in order once by the synchronization server (in the order in which the server receives the requests).

A computer installed with a web browser employing World Wide Web technology (including technology such as HTTP, HTML, etc.) can be considered to be a specific example of an implementation of a terminal representing a document having this structure.

In the following, a description is given of the operation of an image sharing system of this embodiment taking an example of a system configured of an image sharing terminal mounted with a web browser and a document server mounted with a web server.

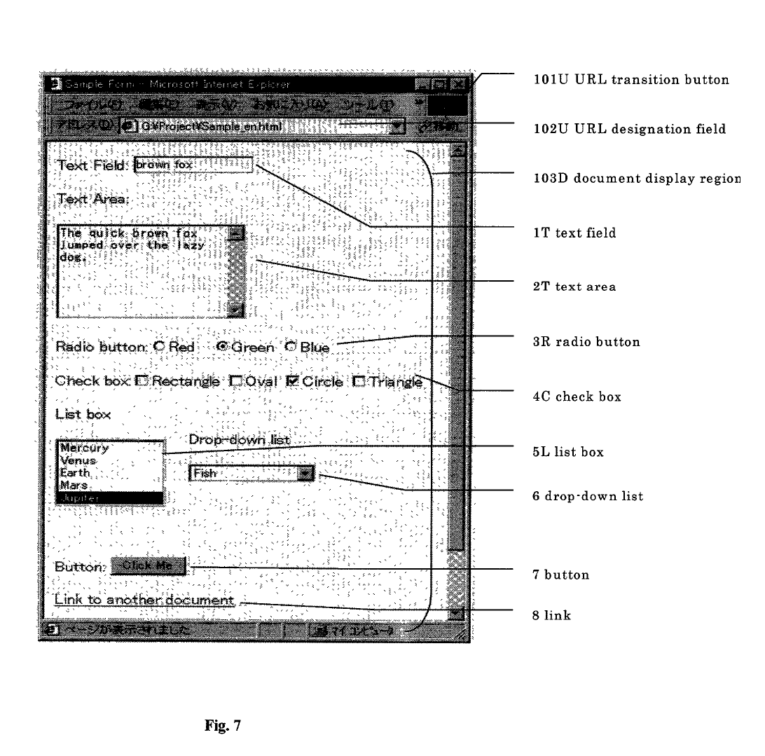

FIG. 7 shows a display example for a document (a document displayed at the display device 5 due to the operation of the document display processor 2 in FIG. 4) displayed at the image sharing terminal. The display example comprises a URL transition button 101U, a URL designation field 102U, and a document display region 103D. The document display region displays documents (an HTML document in the specific example implementation) acquired from the document server. In the display example, this document comprises a text field 1T, text area 2T, radio button 3R, check box 4C, list box 5L, drop-down list 6, button 7 and link 8.

This display example is an example and the document configuration elements from 1 to 8 and these elements can just be employed at the image as necessary. Further, situations where the URL transition button 101U and the URL designation field 102U do not exist can also be considered.

When the image in FIG. 7 is displayed at the image sharing terminal 101 or 102, users of each image sharing terminal can carry out the following operations (A) and (B).

(A) An Operation of Replacing a Document Displayed at the Document Display Region 103D in FIG. 7

(A-1) An Operation Using the URL Designation Field (Numeral 102U in FIG. 7)

(A-2) An Operation Using the Link (8 in FIG. 7)

(B) An Operation of Editing Various Elements Displayed at the Document Display Region 103D in FIG. 7

(B-1) Editing Values

(B-1) Event Occurrence

The following is a description of the respective operations.

(A) An Operation of Replacing a Document Displayed at the Document Display Region 103D in FIG. 7

(A-1) An Operation Using the URL Designation Field (Numeral 102U in FIG. 7)

A URL (typically, a certain type of identifier capable of specifying a document server and including information for making requests to the document server for documents, hereinafter referred to simply as a URL) is inputted at the URL designation field (numeral 102U of FIG. 7) and a URL transition button (101 in FIG. 7) is pressed.

As a result of this operation, a document acquisition request is generated via the document acquisition communication path 111 or 112 with respect to the document server 103S in FIG. 3 and in response, a document is, sent to the image sharing terminal that originally made the request.

(A-2) An Operation Using the Link 8

A link (numeral 8 in FIG. 7) displayed within the document display region 103D of FIG. 7 is pressed using the input device. Information equivalent to a URL for a_destination (A-1) is included at the link, this is interpreted as an equivalent operation to (A-1) by the operation of the document display processor, and a document is acquired by the document server and displayed.

(B) An Operation of Editing Various Elements Displayed at the Document Display Region 103D in FIG. 7

(B-1) Editing Values

Elements of the text field 1T, a text area 2T, a radio button 3R, a check box 4C, a list box 5L and a drop down list 6 are displayed at the document display region 103D of FIG. 7. At these elements, various information is held as text (in the case of a text field or text area) or as a selection state of an item (in the case of a radio button, check box, list box, or drop down list) and this information can be edited as a result of operations by a user.

(B-2) Event Occurrence

An operation defined by some kind of document can then be activated by pushing a button 7 displayed at the character display region 103 of FIG. 7.

When the operations cited above as (A-1), (A-2), (B-1) and (B-2) are carried out at one of the image sharing terminals 101 in FIG. 3, these operations are reproduced at the other image sharing terminal 102. The mechanics of this operation are now described below.

### Operation 1: Image Transition Operation

Operation 1 is executed when the above operation (A) (an operation for changing over a document displayed at the document display region 103D in FIG. 7) is executed, and is a sequence for synchronizing the displays of the image sharing terminals comprising step S101 to step S105. The operation S104 can be divided into steps S104-1 to S104-3, which will now be described in detail.

S101: The image sharing terminal detects notification of document acquisition execution.

S102: An image sharing terminal sends an image transition request to the synchronization server.

S103: The synchronization server holds the image transition request in a queue as a task.

S104: The task is executed upon arrival at the head of the queue.

S104-1: The synchronization server sends an image transition instruction to each image sharing terminal.

S104-2: An image transition is executed at image sharing terminals receiving the instruction.

S104-3: When the image transition is complete, notification of completion is sent to the synchronization server.

S105: When execution of the task is complete, the synchronization server gives notification of the completion of processing to the image sharing terminal that was the source of the request.

The following is a detailed description of the procedure for this operation.

S101: The Image Sharing Terminal Detects Notification of Document Acquisition Execution.

When the operation of (A) is carried out at the image sharing terminal 101 of FIG. 3, the document acquisition is carried out via the communication interface (numeral 1 in FIG. 4) by the document display processor (numeral 2 in FIG. 4) of the image sharing terminal (numeral 101 in FIG. 3). The document sharing processor (numeral 3 in FIG. 4) is notified prior to this (or after waiting for completion of this operation). A URL indicating the document to be newly displayed is included in the document acquisition execution notification.

S102: An Image Sharing Terminal Sends an Image Transition Request to the Synchronization Server.

The document sharing processor (numeral 3 in FIG. 4) receiving the notification sends a request to the synchronization server 104 via the communication interface (numeral 1 in FIG. 4) and the synchronization information communication path 113 of FIG. 3.

S103: The Synchronization Server Holds the Image Transition Request in a Queue as a Task.

The synchronization server receives image transition requested using the request receiver (numeral 2R in FIG. 6) via the communication interface (numeral 1 in FIG. 6). The request receiver of the synchronization server holds the request in the request accumulator once. The held request is referred to as a task in the following. The task is held in a queue once at the request accumulator. The task is not executed unless it reaches the head of the queue. A task at the head of the queue is then a task being executed.

S104: The Task is Executed Upon Arrival at the Head of the Queue.

The task is executed upon arrival at the head of the queue. When execution of the task at the head of the queue is complete, the task is removed from the queue after notification of completion of execution is transmitted to the source of the request, and the next task is brought to the head of the queue and executed. Here, “executing the task” means distributing an image transition instruction to the participating image sharing terminals and waiting for notification of completion from all of the terminals.

S104-1: The Synchronization Server Sends an Image Transition Instruction to each Image Sharing Terminal.

The instruction distributor 3I in the synchronization server of FIG. 6 sends an image 10 transition instruction to image sharing terminals designated as destinations for the distribution of the task to be executed. Distribution destinations are all of the image sharing terminals, including the source of the request.

S104-2: An Image Transition is Executed at Image Sharing Terminals Receiving the Instruction.

When a document sharing processor operating at an image sharing terminal (numeral 102 in FIG. 3) of the distribution destination receives a document designating an image transition instruction (including a URL), the document sharing processor (numeral 3 in FIG. 4) takes the designated URL as a parameter for outputting to the document display processor (numeral 2 in FIG. 4) as a document display request. The document display processor then acquires and displays the same document as is displayed at the image sharing terminal (numeral 101 in FIG. 3) by the document server (numeral 103S in FIG. 3) via the communication interface (numeral 1 in FIG. 4) and the document acquisition communication line (numeral 112 in FIG. 3).

This instruction is also distributed to the image sharing terminal (numeral 101 in FIG. 3) which is the source of the request. If the source of the request has changed to a URL other than the instructed URL for whatever reason, the opposing destination image sharing terminal (102 in FIG. 3) is given an opportunity to get back into synchronism. If the URL at the source of the request has not changed, step S 104-3 is proceeded to without any changes being made.

S104-3: When the Image Transition is Complete. Notification of Completion is Sent to the Synchronization Server.

When an image transition instructed for the image sharing terminals (numeral 102 and 101 of FIG. 3) that are the destination of the request is complete, the image sharing terminals (numeral 102 and 101 of FIG. 3) send notification of completion to the synchronization server (numeral 104 in FIG. 3).

S105: When Execution of the Task is Complete, the Synchronization Server Notifies the Image Sharing Terminal that was the Source of the Request of Completion of Processing and the Task is Removed from the Queue.

When notification of completion is received from all of the terminals, it is taken that execution of the task is complete. When execution of the task is complete, the synchronization server give notification of the completion of processing to the image sharing terminal that was the source of the request. The completed task is then removed from the queue (if a new task is to be proceeded with, execution of this new task is proceeded to).

### Operation 2 (Editing Operation)

Operation 2 is a sequence for ensuring synchronism between image sharing terminals of editing results called up by an operation on the image when the aforementioned operation (B) is carried out and comprises steps S201 to S205. The operation S204 can be divided into steps S204-1 to S204-3, which will now be described in detail.

S201: The image sharing terminal detects notification of document editing.

S202: An image sharing terminal sends an editing results synchronization request to the synchronization server.

S203: The synchronization server holds the editing results synchronization request in a queue as a task.

S204: The task is executed upon arrival at the head of the queue.

S204-1: The synchronization server sends a document change instruction to each image sharing terminal.

S204-2: Changes are made to the document at image sharing terminals receiving the instruction.

S204-3: When changes to the document are completed, notification of completion is sent to the synchronization server.

S205: When execution of the task is complete, the synchronization server notifies the image sharing terminal that was the source of the request of completion of processing.

The following is a detailed description of the procedure for this operation.

S201: The Image Sharing Terminal Detects Notification of Document Editing.

When the operation of (B) is carried out at the image sharing terminal (numeral 101 in FIG. 3) when the same document is displayed at the image sharing terminals 101 and 102 of FIG. 3, notification indicating specific elements configuring the document which are to be edited is issued to the document sharing processor (numeral 3 of FIG. 4) by the document display processor (numeral 2 in FIG. 4) of the image sharing terminal (numeral 101 of FIG. 3). This notification includes information elements of the document configuration to be subjected to editing and contents of the editing processing.

S202: A Image Sharing Terminal Sends an Editing Results Synchronization Request to the Synchronization Server.

The document sharing processor (numeral 3 in FIG. 4) receiving notification interrogates the document display processor (numeral 2 in FIG. 4) for information relating to the elements of the document configuration to be subjected to editing as necessary and edits a message designating notification of changes to the elements configuring the document. A request is then sent to the synchronization server (numeral 104 in FIG. 3) via the communication interface (numeral 1 of FIG. 4) and the synchronization information communication path 113 of FIG. 3.

S203: The Synchronization Server Holds the Editing Results Synchronization Request in a Queue as a Task.

This is the same as step S103 in operation 1. Here, handling of the queue in operation 2 and handling of the queue in operation 1 are the same in a normal implementation.

S204: The Task is Executed Upon Arrival at the Head of the Queue.

The task is executed upon arrival at the head of the queue. When execution of the task at the head of the queue is complete, the task is removed from the queue after notification of completion of execution is transmitted to the source of the request, and the next task is brought to the head of the queue and executed. Here, “executing the task” means distributing a document change instruction to the participating image sharing terminals and waiting for notification of completion from all of the terminals.

S204-1: The Synchronization Server Sends a Document Change Instruction to Each Image Sharing Terminal.

The synchronization server (numeral 104 in FIG. 3) sends a document change instruction to image sharing terminals designated as destinations for the distribution of the task to be executed. Distribution destinations are all of the image sharing terminals, including the source of the request.

S204-2: Changes are Made to the Document at Image Sharing Terminals Receiving the Instruction.

When the document sharing processor (numeral 3 in FIG. 4) operating on the image sharing terminal (numeral 102 in FIG. 3) receives a document change instruction, the document sharing processor (numeral 3 in FIG. 4) of the image sharing terminal (numeral 102 in FIG. 3) requests the document display processor (numeral 2 in FIG. 4) to modify the relating to elements (or generate events) of the document configuration. The document display processor (numeral 2 in FIG. 4) then makes changes (or generates events) with respect to the displayed document configuration elements so that the displayed content matches with the content displayed at the image sharing terminal (numeral 101 in FIG. 3).

This instruction is also distributed to the image sharing terminal (numeral 101 in FIG. 3) which is the source of the request. If the source of the request has changed to display content other than the instructed material for whatever reason, the opposing destination image sharing terminal (102 in FIG. 3) is given an opportunity to get back into synchronism. If there is no change, step S204-3 is proceeded to without any changes being made.

S204-3: When Changes to the Document are Completed. Notification of Completion is Sent to the Synchronization Server.

When a document change instructed for the image sharing terminals (numeral 102 and 101 of FIG. 3) that are the destination of the request is complete, the image sharing terminals (numeral 102 and 101 of FIG. 3) send notification of completion to the synchronization server (numeral 104 in FIG. 3).

S205: When Execution of the Task is Complete, the Synchronization Server Notifies the Image sharing Terminal that was the Source of the Request of Completion of Processing.

This is the same as step S105 in operation 1.

### Effects of First Embodiment

In embodiment 1 described up to this point, all image transitions and image changes are sent once as requests to the synchronization server (numeral 104 in FIG. 3) and are lined up in a queue held by the synchronization server. In addition, displaying of the same image at all of the terminals can be guaranteed because requests are made to execute requests at all terminals including the source of the transmission. The synchronization drift that occurred in the related image sharing systems therefore no longer occurs.

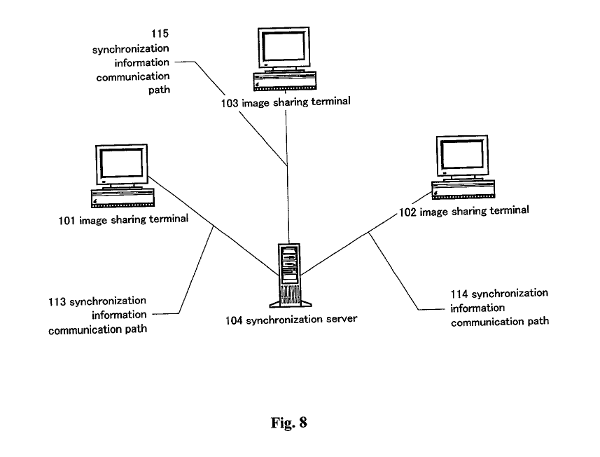

Sharing between scattered sites can also be processed effectively using this method. FIG. 8 shows a configuration when three of the image sharing terminals of FIG. 3 are provided (the document server 103S of FIG. 3 is omitted in FIG. 8).

Taking the number of terminals to be N, the number of communication paths is N. Special processing is not required even if the number of terminals is increased because each image sharing terminal only has to communicate with the synchronization server. This provides superior compatibility when scattered sites are further expanded.

### Second Embodiment

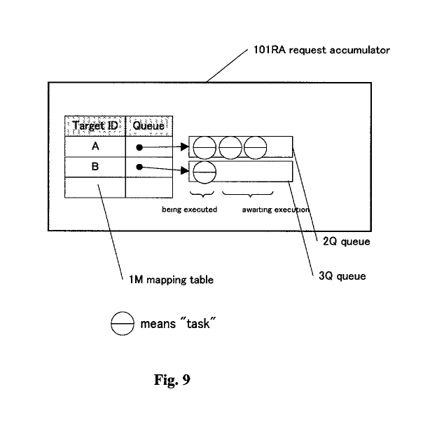

The basic configuration of the second embodiment is the same as the configuration for the first embodiment in FIG. 3, but the configuration and operation of the synchronization server are superior. For ease of description, details of the request accumulator (corresponding to numeral 4R in FIG. 6) of the synchronization server in this embodiment are shown in FIG. 9.

FIG. 9 is a view showing various elements of the configuration within the request accumulator (corresponding to numeral 4R of FIG. 6) for the synchronization server (corresponding to numeral 104 of FIG. 3) of this embodiment. That indicated by numeral 101RA in FIG. 9 is the request accumulator. The request accumulator 101RA comprises a mapping table 1M and queues 2Q and 3Q. The left column of the mapping table 1M is an ID uniquely designating an element of the document, that connects the queues 2Q and 3Q. These queues are generated dynamically by the document structure and tasks are generated for the respective queues.

Here, the possibility of utilizing an ID uniquely indicating an element of the document is stipulated but, to give a specific example implementation, this is possible by implementing the DOM (Document Object Model) specification. With DOM, a W3C relating to Web technology is made and the “Document Object Model (DOM) Level 1 Specification” published as a W3C recommendation is indicated. A specific example of an implementation of this would be the document model provided by Microsoft Internet

### Explorer or Netscape Navigator

The following is a description with reference to FIG. 9 of the case where the operation (B) (an operation of editing various elements displayed at the document display region 103D of FIG. 7) is carried out at the image sharing terminal 101 of FIG. 3. The operation (operation 3) executed at this time is similar to the operation 2 already described and therefore mainly portions differing to the operation 2 are described.

### Operation 3 (Editing Operation)

The steps executed in operation 3 are as follows.

S301: The image sharing terminal detects notification of document editing.

S302: An image sharing terminal sends an editing results synchronization request to the synchronization server.

S303: The synchronization server holds the editing results synchronization request in a queue as a task.

S304: The task is executed upon arrival at the head of the queue.

S304-1: The synchronization server sends a document change instruction to each image sharing terminal.

S304-2: Changes are made to the document at image sharing terminals receiving the instruction.

S304-3: When changes to the document are completed, notification of completion is sent to the synchronization server.

S305: When execution of the task is complete, the synchronization server notifies the image sharing terminal that was the source of the request of the completion of processing.

Only steps S301, S303 and S305 in the series of steps for operation 3 differ from steps in operation 2. The following is a detailed description of the operation of these steps.

S301: The Image Sharing Terminal Detects Notification of Document Editing.

Operation 2 is substantially the same as step S201. However, in this case an ID uniquely specifying an element of the document configuration of the document to be edited is added to the transmitted message, with this ID being utilized in step S303. The possibility of acquiring this kind of ID is as described previously in the example implementation of the DOM (Document Object Model) specification.

S303: The Synchronization server Holds the Editing Results Synchronization Request in a Queue as a Task.

The synchronization server (numeral 104 of FIG. 3) receives the editing results synchronization request using the request receiver (numeral 2R in FIG. 6) via the communication interface (numeral 1 in FIG. 6). The request receiver of the synchronization server (numeral 2R in FIG. 6) holds the request in the request accumulator (numeral 4R of FIG. 6) once.

The queue of tasks held by the request accumulator (numeral 4R in FIG. 6) holds the document configuration element ID's captured by each image synchronizing terminal in step S301, with the requests held being managed as tasks. Queues (numeral 2Q and numeral 3Q in FIG. 9) corresponding to the document configuration element ID's acquired by each terminal in step S301 in the mapping table 1M of FIG. 9 at the request accumulator (numeral 4R in FIG. 6) are retrieved, and the tasks are then linked to these queues. When a queue does not yet exist, a queue is generated and a task is housed at the head of the queue. As in step S203, the task is not executed unless it reaches the head of the queue. A task at the head of the queue is then a task being executed. As there is a plurality of queues, a plurality of tasks being executed in parallel exist for each document configuration element.

S305: When Execution of the Task is Complete, the Synchronization Server Notifies the Image Sharing Terminal that was the Source of the Request of Completion of Processing.

When a notification of completion is received from each image sharing terminal, a mapping table (numeral 1M of FIG. 9) for retrieving which task the completion is linked to is retrieved.

When notification of completion is received from all of the image sharing terminals, it is taken that execution of the task is complete. When execution of the task is complete, the synchronization server gives notification of the completion of processing to the image sharing terminal that was the source of the request. The completed task is then removed from the queue (if a new task is to be proceeded with, execution of this new task is proceeded to).

### Effects of Second Embodiment

Synchronization drifts do not occur in the method of the first embodiment, but there is a problem in that an excessive amount of time can be required to provide synchronism at the synchronization server when mutual inputting is carried out (the related art is rapid but synchronization drift occurs).

This is described in detail in the following with reference to FIG. 3.

For example, it is taken that a document configuration element A is edited at the image sharing terminal 101 and that a document configuration element B is edited at the image sharing terminal 102 at substantially the same time. Each image sharing terminal then detects edits, and sends change requests to the synchronization server. There are, however, occurrences where the request for element A issued from the image sharing terminal 101 of the two change requests arrives/is received first.

Assuming that there is nothing in the queues in the initial state of the synchronization server 104, in this case, the request of the image sharing terminal 101 is executed immediately and a document change instruction is sent to the image sharing terminal 102. On the other hand, the change request from the image sharing terminal 102 is not executed until the change request from the image sharing terminal 101 is complete (i.e. the image sharing terminal 102 receives an instruction relating to element A, a document configuration element is changed, notification of completion is returned to the synchronization server 104, this is received by the synchronization server 104, and the task is removed from the queue).

With regards to this, when the method of the second embodiment is adopted, change requests from the image sharing terminal 101 are held in a queue for element A, and change requests from the image sharing terminal 102 are held in the queue for element B. Requests from the image sharing terminal 102 are therefore executed immediately.

When a change request from the image sharing terminal 102 also relates to element A, this change request is similarly held in a queue as in the method of the first embodiment, and execution of the request from the image sharing terminal 102 has to wait until completion of the request from the image sharing terminal 101. Finally, what is executed at both terminals relates to requests from the image sharing terminal 102, and, as with the method of the first embodiment, problems with synchronization drifts do not occur.

As shown above, in the method of the second embodiment, problems with synchronization drift do not occur (as in the method of the first embodiment) and performance can be improved when editing different portions of the same document in parallel between image sharing terminals.

### Third Embodiment

The configuration of this embodiment is the same as the configuration for the first embodiment and a description thereof is therefore omitted.

The following is a description with reference to FIG. 3 of the case where the operation (B) (an operation of editing various elements displayed at the document display region 103D of FIG. 7) is carried out at the image sharing terminal 101. In this embodiment, the operation is slightly different depending on which of the operations (B-1) and (B-2) described previously is performed.

The operation (operation 3) executed at this time is similar to the operation 2 already described and therefore mainly portions differing to the operation 2 are described. Operation 4 (Editing Operation)

The steps executed in operation 4 are as follows.

S401: The image sharing terminal detects notification of document editing.

S402: The image sharing terminal sends a synchronization request to the synchronization server in a mode designated by the operation content of step S401.

S403: The synchronization server holds the editing results synchronization request in a queue as a task.

S404: The task is executed upon arrival at the head of the queue.

S404-1: The synchronization server sends a document change instruction to an image sharing terminal designated in step 402.

S404-2: Changes are made to the document at image sharing terminals receiving the instruction.

S404-3: When changes to the document are completed, notification of completion is sent to the synchronization server.

S405: when execution of the task is complete, the synchronization server notifies the image sharing terminal that was the source of the request of completion of processing.

Only steps S402, S403 and S404-1 in the series of steps for operation 4 differ from steps in operation 2. The following is a detailed description of the operation of these steps.

S402: The Image Sharing Terminal Sends a Synchronization Request to the Synchronization Server in a Mode Designated by the Operation Content of Step S401.

When the operation (B-1) (for example, editing of a text field) is carried out with the operation content of step S401, a document change instruction to be distributed is set to “all terminals” in the document of the synchronization request. When operation content of (B-2) is carried out (for example, pressing a button), the document change instruction for distribution is set to “all terminals excluding the terminal itself”.

S403: The Synchronization Server Holds the Editing Results Synchronization Request in a Queue as a Task.

This is substantially the same as step S203 but the instructions “all terminals” and “all terminals excluding the terminal itself” regarding the distribution destination designated in step S402 as content to be held as the task has to be held.

S404-1: The Synchronization Server Sends a Document Change Instruction to an Image Sharing Terminal Designated in Step S402.

This is substantially the same as step S204-1 of operation 2. However, with regards to image sharing terminals that are the destination of the transmission definitely being all the participating terminals in step S204-1, in this step, when the distribution destination instruction recorded in this task is “all terminals”, as with the step S204-1, a document change instruction (specifically, a text field edit instruction) is sent to all of the image sharing terminals. When the distribution destination instruction recorded in this task is “all terminals excluding the terminal itself”, an instruction (specifically, an event occurrence instruction corresponding to a button link) is sent to all of the image sharing terminals with the exception of the source of the request.

### Effects of Third Embodiment

In the first embodiment, there was a problem with regards to sharing between each image sharing terminal in the operation (B-2). Specifically, giving an example of sharing a button pressing event, when a button of the image sharing terminal that is the source of a request is pressed (so that normally an operation corresponding to the pressing of the button is executed), an accompanying event occurrence request is also distributed to the terminal that is the source of the request. As a result, the operation accompanying the pressing of the button becomes the source of a request twice.

In order to avoid this in the first embodiment, a first occurrence of a button pressing event for the request source image sharing terminal is completely intercepted so as to have absolutely no effect. From this interception, a request to share a button pressing event is made to the server, and the effects of the button click will then appear for the first time when an event generation instruction comes from the server. As this means that there is a time delay between pressing the button and execution, this may make the user feel uncomfortable or usefulness may be reduced due to the drop in speed (in the case of editing a text field (operation B-1), there are no problems with the procedure where editing is performed immediately and an edit instruction is then carried out again another time from the server).

With regards to this, in this method the user is prevented from feeling uncomfortable and a fall in usefulness is prevented by handling the type of operation for (B-2) using a separate method to that for the type of operation of (B-1). This guarantees that an operation suited to image sharing can be performed.

### Fourth Embodiment

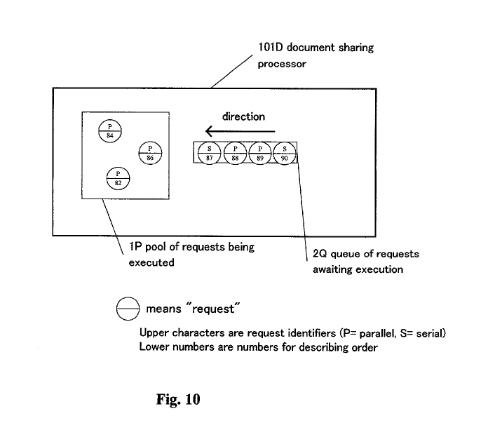

The basic configuration of the fourth embodiment is the same as the configuration for the first embodiment in FIG. 3 and the second embodiment of FIG. 9, but the configuration and operation of the image sharing terminals is superior. For ease of description, details of the document sharing processor (corresponding to numeral 3 in FIG. 4) of an image sharing terminal in this embodiment are shown in FIG. 10.

The following is a description, with reference to FIG. 10 and FIG. 4, of the case where the operation (B) (an operation of editing various elements displayed at the document display region 103D of FIG. 7) is carried out at the image sharing terminal 101 of FIG. 3.

### Operation 5 (Editing Operation)

The operation (operation 5) executed at this time is similar to the operation 3 already described and therefore mainly portions differing to the operation 3 are underlined for ease of understanding.

S501: The image sharing terminal detects notification of document editing.

S501-1: The Document Display Processor (Numeral 2 of FIG. 4) Within the Image Sharing Terminal Notifies the Document Sharing Processor (Numeral 3 of FIG. 4) of Detected Content.

S502: A image sharing terminal sends an editing results synchronization request to the synchronization server.

S502-1: The Document Sharing Processor Determines the Type of the Notified Detected Content and Makes Request Content. Requests During this Time are Taken to be Either in “Parallel” or “Serial” (Described Later).

S-502-2: Requests Made in this Manner are Held at the End of a Queue (Numeral 20 in FIG. 10) Awaiting Execution.

S502-3: The Content of the Request at the Head of the Queue Awaiting Execution is Sent to the Synchronization Server Based on Certain Conditions (Described Later).

S502-4: Transmitted Requests are then Held Once in a Pool of Requests (Numeral 1P of FIG. 10) Awaiting Execution.

S503: The synchronization server holds the editing results synchronization request in a queue as a task.

S504: The task is executed upon arrival at the head of the queue.

S504-1: The synchronization server sends a document change instruction to each image sharing terminal.

S504-2: Changes are made to the document at image sharing terminals receiving the instruction.

S504-3: When changes to the document are completed, notification of completion is sent to the synchronization server.

S505: When execution of the task is complete, the synchronization server gives notification of the completion of processing to the image sharing terminal that was the source of the request.

S506: When the Image Sharing Terminal that Made the Request Receives Notification of Completion, the Corresponding Request Entry Held in the Pool (Numeral 1P in FIG. 10) of Requests Being Executed is Deleted.

The flags of “parallel” and “serial” for step S502-1 are flags that are valid only within this particular terminal and are decided by the type of detection content notified by pre-defined rules.

The execution conditions in step S502-3 (the conditions for where request entries coming to the head of the queue awaiting execution are actually transmitted, removed from the queue awaiting execution, and put into the pool of requests being executed) are as follows.

C1: When there is nothing in the pool of requests being executed, the request entry coming to the head of the queue awaiting execution is executed (whether parallel or serial).

C2: When there are parallel request entries in the pool of requests being executed, the request entry coming to the head of the queue awaiting execution is executed if this request entry is parallel.

C3: When there are parallel request entries in the pool of requests awaiting execution, if the entry coming to the head of the queue awaiting execution is serial, the entry is awaited (a parallel request entry of the pool of requests being executed is detected by the operation of step S506, and as a result, fulfillment of a condition C1 is awaited).

C4: When there are serial request entries in the pool of requests awaiting execution, the entry coming to the head of the queue awaiting execution is awaited (whether this is parallel or serial) (a serial request entry of the pool of requests being executed is deleted by the operation of step S506, and as a result, fulfillment of a condition C1 is awaited).

As can be deduced from the above conditions, when there is a serial request entry in the pool of requests awaiting execution, this is the only request entry that can be present, and other request entries therefore cannot be present (regardless of whether the requests are parallel or serial). This means from the point of view of each image sharing terminal that the number of serial requests being executed simultaneously at the server can only be one at most.

With respect to this, with parallel requests, a plurality of requests can be in the pool of requests being executed at the same time. This means that a plurality of the parallel requests of the requests being executed can be present in parallel at the server.

### Effects of Fourth Embodiment

In the method of the second embodiment, editing operations and event occurrence with respect to each configuration element comprising the image is proceeded with independently and an order between each element configuring the image is not guaranteed (order is guaranteed with respect to respective image configuration elements but order is not guaranteed when looking at a plurality of elements). This is the possibility that elements edited and operated upon in the order of element A, element B and element C on one side may reappear on another side in the order of element A, element C and element B, which is a possible inconvenience during use. This is now described in detail using an example.

For example, with the configuration of FIG. 3, the image of FIG. 7 is displayed at the image sharing terminals (numeral 101 and 102 of FIG. 3). It is then assumed that the following series of operations are carried out in this order at the image sharing terminal (numeral 101 of FIG. 3) in this state.

(1) “aaa” is Inputted to the Text Field (Numeral 1T of FIG. 7)

(2) “Amphibian” is Selected at a Drop-down List (Numeral 6 of FIG. 7).

(3) A Button (Numeral 7 of FIG. 7) is Pressed.

At the button, it is taken that an operation to reflect edited content of the document at this time is carried out (specifically, a method is considered where, assuming typical WWW technology, when the button is clicked, a POST request is issued to the document server (numeral 103S in FIG. 3) using content taken from the content of the text field and the drop-down list).

When the order between the elements cannot be guaranteed, there is the possibility that the operations with be reproduced in the order (1)(3)(2) at the image sharing terminal (numeral 102 in FIG. 3). Namely, first, the text field is edited, the button is pressed, and selection is then carried out using the drop-down list.

When this occurs, the content of the text field and the drop-down list is reflected at the terminal (numeral 101 of FIG. 3) due the operation of pushing the button but at the terminal (numeral 102 of FIG. 3) just changes to the text field are reflected.

With regards to this, according to the fourth embodiment, this can be handled as a “serial request” simply by pressing down the button. In cases handled in this manner, there is the chance that (1)(2) may become back to front but there is no possibility that (3) will not appear until both (1) and (2) are complete. Namely, it can be guaranteed that both the text field and the drop-down list operate at the time of pressing the button down.

n this method, in addition to maintaining the benefits of improved performance of the method of the second embodiment, an order relationship is provided partially between elements configuring the document and the order in which events are reproduced can be maintained between image sharing terminals as necessary.

A specific application of the present invention is utilization at a place of business of a financial institution.

For example, in network systems providing unattended stores etc. for outlets of financial institutions, there exist systems comprising terminal devices operated by customers and terminal devices connected to a network and operated by an operator. Basically, the customer is inexperienced when it comes to operating the terminal but the person (operator) on the information providing side is knowledgeable with regards to operation of the terminal but the customer information itself cannot be known without asking the customer. In this case, requests it is wished to execute in an efficient manner in parallel with the input on both sides are outputted (for example, an amount of money is inputted on the customer side and an address etc. is inputted on the operator side). It is not permissible for the content displayed at both terminals at this kind of outlet of a financial institution to not match. The present invention therefore provides an image sharing system principally capable of being compatible with this kind of business.

Utilization in on-line shopping over the internet can also be considered as a further utilization of the present invention.

A system configuration for image sharing terminals of the present invention can also be considered for, for example, customer terminals (personal computers, etc.) connected to the internet and computers operated by operators of a merchant help desk.

In this way, it is possible for operators of merchant help desks to converse with customers and provide product information desired by the customers.

What is claimed is:

1. An image sharing system for displaying a shared image at a plurality of computer display devices connected via a network, and provided with a synchronization server connected to the plurality of computers via the network,
wherein the synchronization server comprises:
receiving means for receiving content of operations carried out at the plurality of computers;
accumulating means for accumulating and assigning order in order of receipt to received operation content; and
distribution means for distributing operation content accumulated at the accumulating means to the plurality of computers in the order of accumulation.

2. The image sharing system of claim 1, wherein the accumulating means of the synchronization server accumulates content for operations received from the plurality of computers in such a manner as to assign order in units of elements comprising content displayed at display devices of the plurality of computers.

3. The image sharing system of claim 1 or claim 2, wherein the distribution means of the synchronization server receiving content of operations adds identification information for identifying which operation of “distribute to all of the plurality of computers connected via the network”, or “distribute to all of the computers connected via the network excluding the computer sending to the synchronization server” is to be performed as attribute information for the operation content for content of each operation of the plurality of computers received by the synchronization server.

4. The image sharing system of any one of claims 1 to 3, wherein each of the plurality of computers connected via the network are provided with operation content transmission means for delaying transmission of operation content to the synchronization server according to content of the operation.

5. The image sharing system of any one of claims 1 to 4, wherein the plurality of computers connected via the network are either customer operated terminal devices of a financial institution or terminal devices operated by an operator.

6. The image sharing system of any one of claims 1 to 4, wherein the plurality of computers connected via the network are either personal computers of customers carrying out on-line shopping connected to the internet or computer terminals operated by operators of a merchant-side help desk.
